(19) United States
(12) Patent Application Publication
(10) Pub. No.: US 2026/0208919 A1
(43) Pub. Date: Jul. 23, 2026

(54) Double Pill Bottle

(71) Applicant: Zachery F. Smith, Orange, CA (US)

(72) Inventor: Zachery F. Smith, Orange, CA (US)

(21) Appl. No.: 19/274,188

(22) Filed: Jul. 18, 2025

Related U.S. Application Data
(60) Provisional application No. 63/748,238, filed on Jan. 22, 2025.

(51) Int. Cl. B65D 25/04; B65D 41/04

(52) U.S. Cl. CPC B65D 25/04; B65D 41/04

(57) ABSTRACT

A medicine pill bottle having a cylinder body that is separated into two different compartments. The cylinder body has a top open end being a main top compartment and a bottom open end being a secondary bottom compartment. The main top compartment is connected to the secondary bottom compartment, wherein the two compartments share a closed end. The main top compartment has a larger volume than the secondary bottom compartment. The main top compartment has a top cap, and the secondary bottom compartment has a bottom cap. Both the top cap and the bottom cap include a childproof safety lock. The top cap has a defined color, and the bottom cap has a defined color, wherein the color of the top cap is different than the color of the bottom cap. The color of top cap and the color of the bottom cap is a visual indicator defining the main top compartment and the secondary bottom compartment.

### FIELD OF THE DISCLOSURE

The present invention relates to generally to a pill bottle used to store pills, in particular a medicine pill bottle used to hold a prescription of medication.

### BACKGROUND OF THE INVENTION

A medicine pill bottle is a container that holds medication pills for a prescription, wherein the pills are protected from the environment. The quantity of pills that make up the prescription can vary from a number of days, weeks, or even months. Depending on the duration of the medication, the prescription is refilled accordingly, wherein the supply of medication pills provided lasts anywhere from 30 days (one month) to 90 days (three months). The patient bears the responsibility of having the prescription refilled at the appropriate time so as to not run out of their current medication before receiving their refill. There is a concern that such a situation may occur, wherein waiting for the refill of their prescription the patient is left without any medication, which can potentially impact their current medical condition.

### SUMMARY OF THE INVENTION

The present invention is means for a patient to keep track of the prescription and ensure they have enough of their medication on-hand as they await their refill. The present invention allows the patient to store an additional supply of their medication as a holdover until receiving their prescription refill.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a perspective view of the present invention;

FIG. 2 is a top view of the present invention;

FIG. 3 is a left view of the present invention;

FIG. 4 is a front view of the present invention;

FIG. 5 is a bottom view of the present invention;

FIG. 6 is a right view of the present invention;

FIG. 7 is a back view of the present invention;

FIG. 8 is left perspective view from bottom to top of the present invention;

FIG. 9 is a right perspective view from top to bottom of the present invention;

FIG. 10 is a right perspective view from bottom to top of the present invention;

FIG. 11 is front view of the present invention;

FIG. 12 is front perspective view from top to bottom of the present invention;

FIG. 13 is a top perspective view from top to bottom of the present invention;

FIG. 14 is a bottom perspective view from bottom to top of the present invention.

All illustrations of the drawings are for the purpose of describing selected versions of the present invention and are not intended to limit the scope of the present invention.

### DETAILED DESCRIPTION

In the Summary of the Invention above, in this Detailed Description, in the Claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

The term “comprises”, and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “dorsal” refers to positions that are located near, on, or towards the top or top side of a structure.

The present description includes one or more non-limiting embodiments of a double pill bottle.

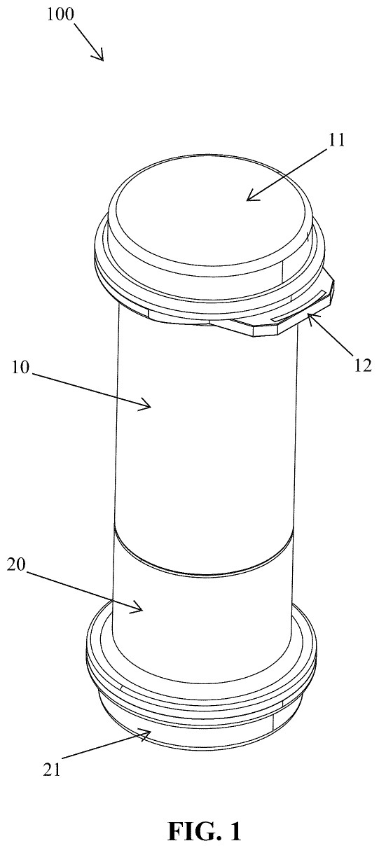

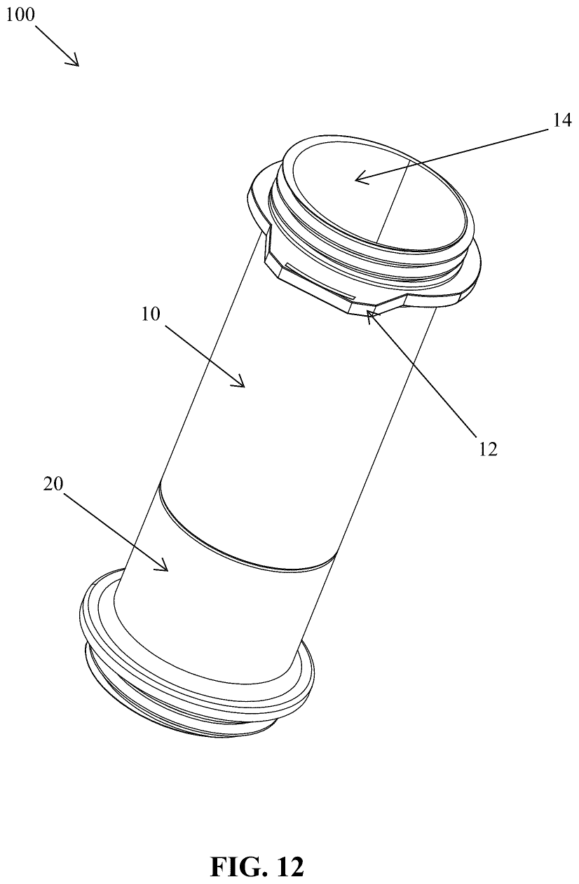

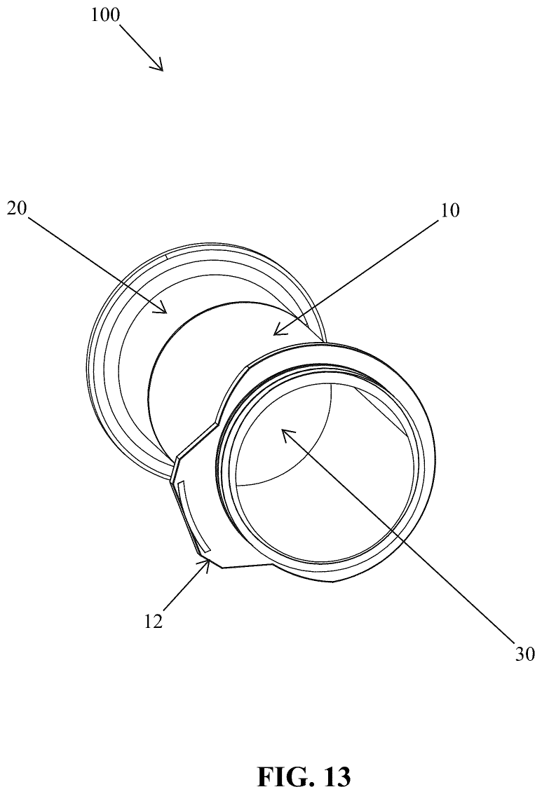

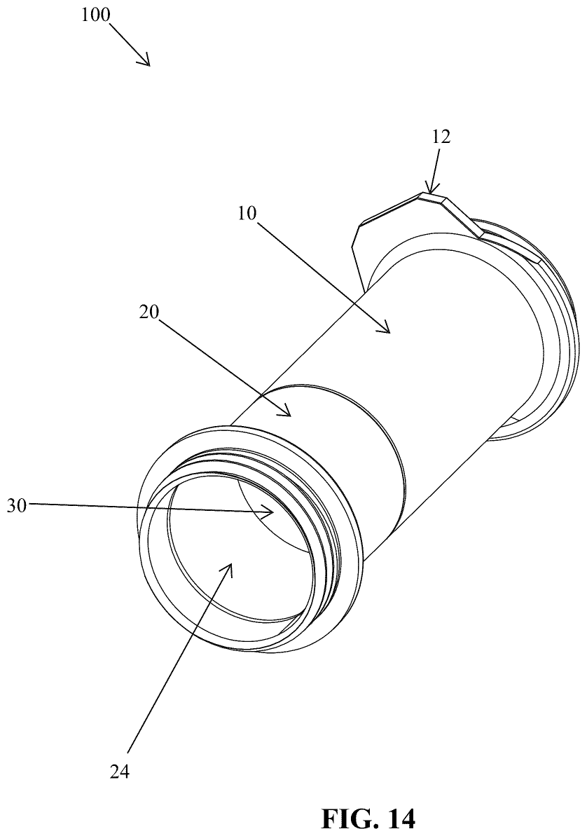

Referring now to FIG. 1, FIG. 1 is a perspective view of the present invention, a double pill bottle 100. The double pill bottom is comprised of a cylinder body split into two separate connected compartments, a main top compartment 10 having a top open end 14 (See FIG. 12) covered by a top cap 11 and a secondary bottom compartment 20 having a bottom open end 24 (See FIG. 14) covered by a bottom cap 21. The main top compartment 10 shares a closed base 30 (See FIG. 13 and FIG. 14) with the secondary bottom compartment 20. In the present embodiment, the double pill bottle 100 includes a push tab 12 for the top cap 12. In a preferred embodiment, a push tab is included for the bottom cap 21.

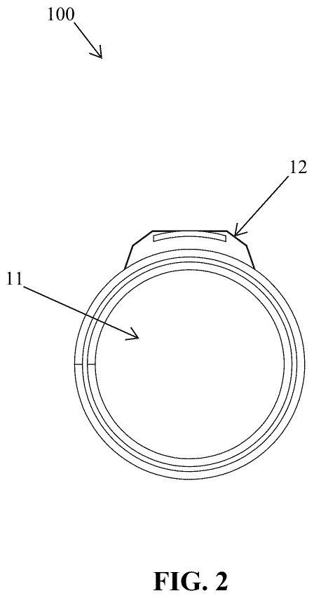

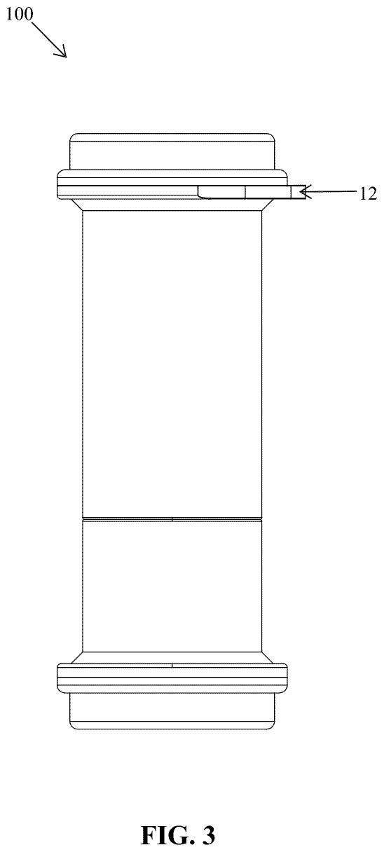

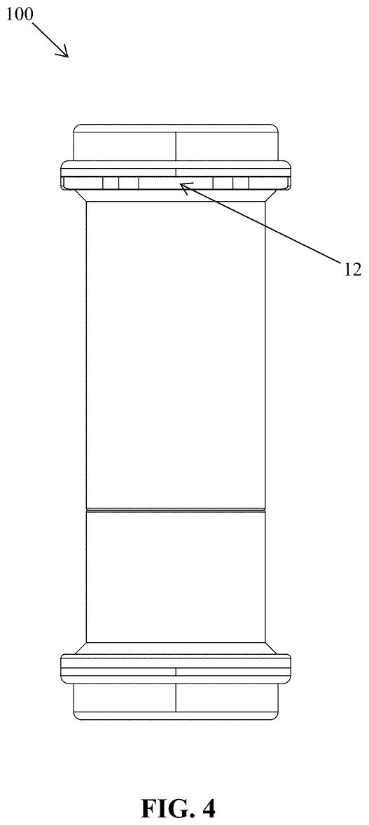

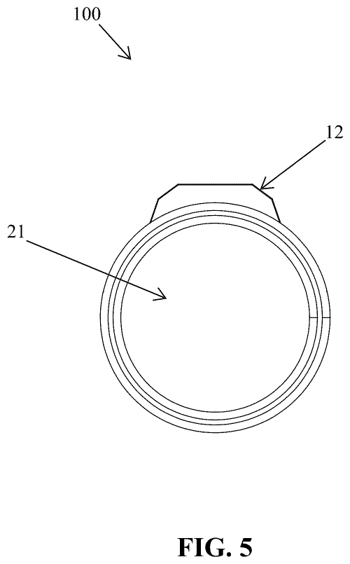

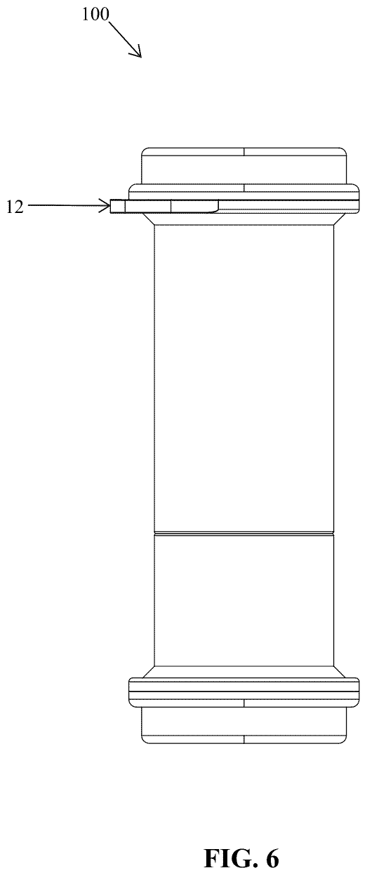

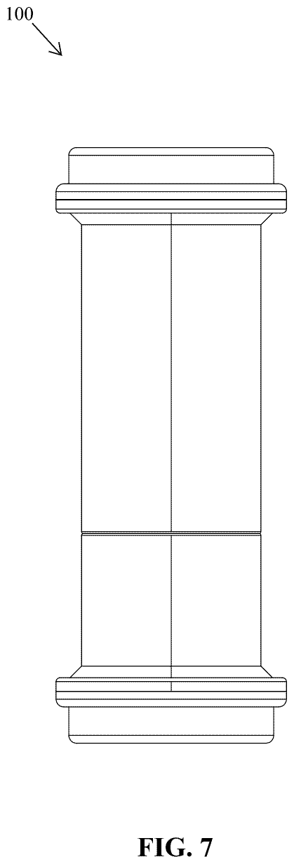

Referring to FIG. 2-7 , FIG. 2 is a top view of the double pill bottle 100; FIG. 3 is a left view of the double pill bottle 100; FIG. 4 is a front view of the double pill bottle 100; FIG. 5 is a bottom view of the double pill bottle 100; FIG. 6 is a right view of the double pill bottle 100; and FIG. 7 is a back view of the double pill bottle 100.

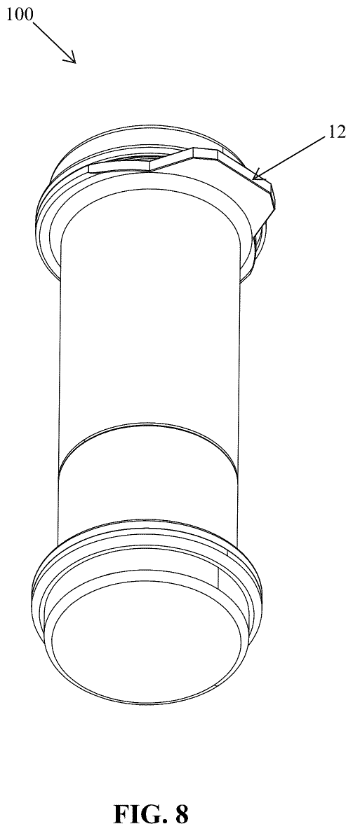

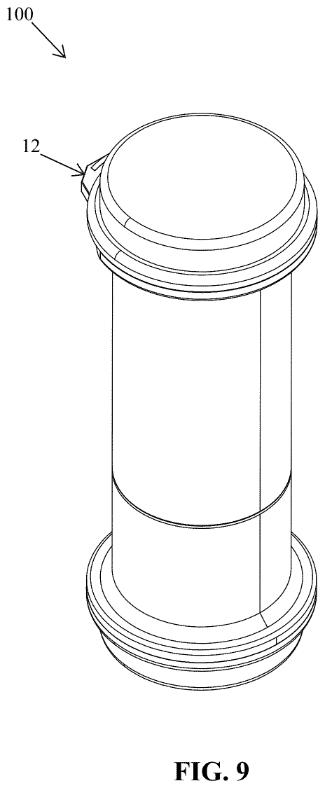

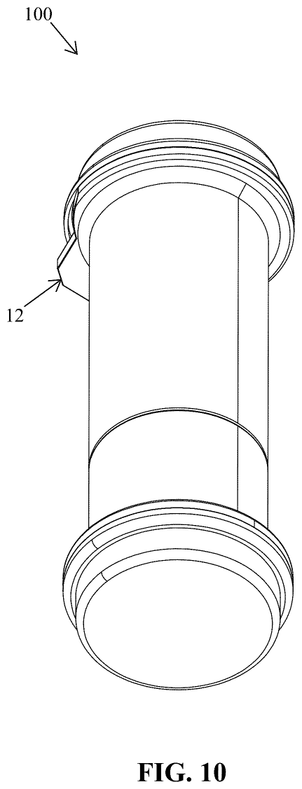

Referring to FIG. 8-10 , FIG. 8-10 are various perspective views of the double pill bottle 100. FIG. 8 and FIG. 10 are bottom perspective views of the double pill bottle 100, and FIG. 9 is a top perspective view of the double pill bottle 100.

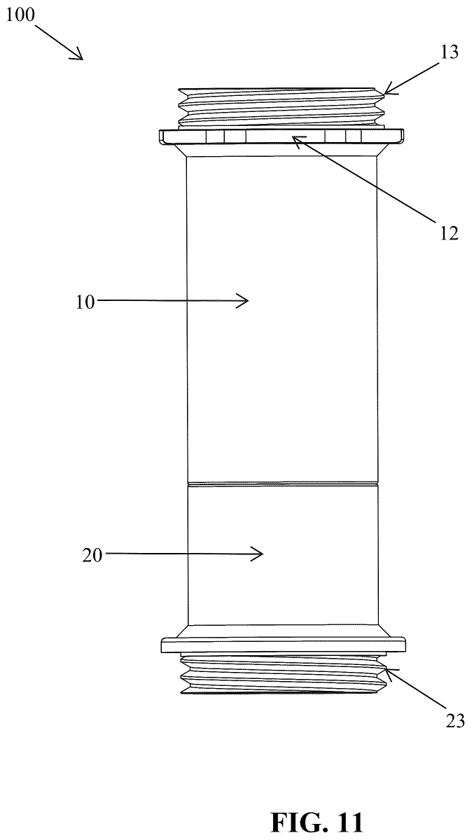

Referring to FIG. 11, FIG. 11 is a front view of the double pill bottle 100 wherein the cylinder body includes a threaded top open end 13 and a threaded bottom open end 23.

Referring to FIG. 12-14 , FIG. 12 is a top perspective view of the double pill bottle 100 displaying the top open end 14. FIG. 13 is a top perspective view of the double pill bottle 100 displaying the shared closed base 30 connecting the main top compartment 10 with the secondary bottom compartment 20. FIG. 14 is a bottom perspective view of the double pill bottle 100 displaying the bottom open end 24.

The present invention is a double pill bottle. The double pill bottle is a medicine pill bottle split into two separate connected compartments. The body of the double pill bottle is a cylinder comprised of a main top compartment connected to a secondary bottom compartment. Each compartment has an open end, wherein the two compartments share a closed bottom end. The two compartments are unequal in size. In a preferred embodiment, the secondary bottom compartment is approximately 15-20% smaller in volume than the main top compartment. There is a top cap for the main top compartment and a bottom cap for the secondary bottom compartment. Each cap has a designated color, wherein the color of top cap of the main top compartment is different from the bottom cap of the secondary bottom compartment. The color of top cap and the bottom cap is a visual indicator as to whether the particular compartment is the main top compartment or the secondary bottom compartment. Additionally, in the present embodiment, the main top compartment includes a push tab that functions as a childproof lock.

In a preferred embodiment, a patient would divide up their given medical prescription supply between the two compartments of the double pill bottle. The medication would be divided up such that the main top compartment would hold a majority of the medication, while the secondary bottom compartment would hold a supply corresponding to a time duration needed for the patient to typically refill their prescription. The main top compartment becoming empty would trigger the patient to submit a refill for their prescription. The patient would then use the supply of medication located in the secondary bottom compartment of the double pill bottle until receiving a refill prescription. Upon receiving the refilled prescription, the patient would once again divide up the medication between the main top compartment and the secondary bottom compartment, wherein the main top compartment would be refilled minus an amount used to replenish the secondary bottom compartment. The secondary bottom compartment would be replenished with an amount of medication corresponding to the time duration needed to refill the prescription.

In another embodiment of the of the present invention, the main top compartment has a volume that is 80% of the total volume of the double pill bottle, and the secondary bottom compartment has a volume that is 20% of the total volume of the double pill bottle. Each compartment has an open end, wherein the two compartments share a closed end.

In another preferred embodiment of the present invention, the double pill bottle includes a push tab childproof lock for the bottom cap of the secondary bottom compartment.

Although the invention has been explained in relation to its preferred embodiment, it is to be understood that many other possible modifications and variations can be made without departing from the spirit and scope of the invention.

What is claimed is:

1. A pill bottle comprising:
a cylinder body having a top open end and a bottom open end, wherein the cylinder body is comprised of a main top compartment that shares a connected closed base with a secondary bottom compartment;
a top cap that connects to the main top compartment; and
a bottom cap that connects to the secondary bottom compartment.

2. The pill bottle of claim 1, wherein the top cap is configured for the top opened end.

3. The pill bottle of claim 2, wherein the bottom cap is configured for the bottom open end, the configuration of the bottom cap being different from the configuration of the top cap.

4. The pill bottle of claim 3, wherein the top open end includes threads, and the top cap includes threads configured to mate with the threads of the top open end.

5. The pill bottle of claim 4, wherein the bottom open end includes threads, and the bottom cap includes threads configured to mate with the threads of the bottom open end.

6. The pill bottle of claim 5, wherein the top open end includes a push tab below the threads of the top open end, the push tab locks the top cap in place when the top cap is rotated onto the top open end.

7. The pill bottle of claim 6, wherein the bottom open end includes a push tab below the threads of the bottom open end, the push tab locks the bottom cap in place when the bottom cap is rotated onto the bottom open end.

8. The pill bottle of claim 7, wherein a volume of the secondary bottom compartment is 15-20% smaller in volume than the volume of the main top compartment.

9. The pill bottle of clam 7, wherein the main top compartment has a volume that is equal to 80% of the total volume of the cylinder body of the pill bottle, and the secondary bottom compartment has a volume that is equal to 20% of the total volume of the cylinder body of the pill bottle.

10. A pill bottle comprising;
a cylinder body having a top open end and a bottom open end, wherein the cylinder body is comprised of a main top compartment that shares a connected closed base with a secondary bottom compartment;
a top cap that connects to the main top compartment, wherein the top cap is configured for the top opened end; and
a bottom cap that connects to the secondary bottom compartment, wherein the bottom cap is configured for the bottom open end.

11. The pill bottle of claim 10, wherein the configuration of the top cap is different from the configuration of the bottom cap.

12. The pill bottle of claim 11, wherein the top open end includes threads, and the top cap includes threads configured to mate with the threads of the top open end.

13. The pill bottle of claim 12, wherein the bottom open end includes threads, and the bottom cap includes threads configured to mate with the threads of the bottom open end.

14. The pill bottle of claim 13, wherein the top open end includes a push tab below the threads of the top open end, the push tab locks the top cap in place when the top cap is rotated onto the top open end.

15. The pill bottle of claim 14, wherein the bottom open end includes a push tab below the threads of the bottom open end, the push tab locks the bottom cap in place when the bottom cap is rotated onto the bottom open end.

16. The pill bottle of claim 15, wherein a volume of the secondary bottom compartment is 15-20% smaller in volume than the volume of the main top compartment.

17. The pill bottle of clam 15, wherein the main top compartment has a volume that is equal to 80% of the total volume of the cylinder body of the pill bottle, and the secondary bottom compartment has a volume that is equal to 20% of the total volume of the cylinder body of the pill bottle.

18. A pill bottle comprising;
a cylinder body having a threaded top open end and a threaded bottom open end, wherein the cylinder body is comprised of a main top compartment having a volume equal to 80% of a volume of the cylinder body of the pill bottle, and a secondary bottom compartment having a volume equal to 20% of the volume of the cylinder body of the pill body, wherein the main top compartment and secondary bottom compartment share a closed connected base;
a top cap that connects to the main top compartment, wherein the top cap is configured to mate with the top open end; and
a bottom cap that connects to the secondary bottom compartment, wherein the bottom cap is configured to mate with the bottom open end.

19. The pill bottle of claim 18, wherein the configuration of the top cap is different from the configuration of the bottom cap.

20. The pill bottle of claim 18, wherein the top open end includes a push tab below the threads of the top open end that locks the top cap in place when the top cap is rotated onto the top open end, and a push tab below the threads of the bottom open end that locks the bottom cap in place when the bottom cap is rotated onto the bottom open end.
